(19) United States
(12) Patent Application Publication
(10) Pub. No.: US 2018/0355282 A1
(43) Pub. Date: Dec. 13, 2018

(54) PROCESSES FOR STRUCTURING DETERGENT COMPOSITIONS

(71) Applicant: The Procter & Gamble Company, Cincinnati, OH (US)

(72) Inventors: Vincenzo GUIDA, Woluwe St. Pierre (BE); Jef Annie Alfons MAES, Sint Niklaas (BE); Antonio QUINTIERI, Waterloo (BE)

(21) Appl. No.: 16/001,984

(22) Filed: Jun. 7, 2018

(30) Foreign Application Priority Data
Jun. 8, 2017 (EP) 17174981.5
Jan. 26, 2018 (EP) 18153634.3

(51) Int. Cl. C11D 1/831; C11D 3/20

(52) U.S. Cl. CPC C11D 1/831; C11D 1/72; C11D 3/2079; C11D 3/2086

(57) ABSTRACT

The need for a process for making a structured liquid detergent composition which comprises a structurant without introducing high levels of water or emulsifying agents, or requiring a separate structuring premix to be formed, is met herein.

### FIELD OF THE INVENTION

Process for structuring detergent compositions, especially low water liquid detergent compositions.

### BACKGROUND OF THE INVENTION

Crystalline structurants, such as hydrogenated castor oil, have been used to structure and thicken liquid compositions, including liquid detergent compositions. Typically, a structurant premix is first made, which comprises the crystalline structurant preformed into a network in an aqueous composition. For instance, WO 2002/040627 describes structuring premixes systems comprising a crystalline, hydroxyl-containing stabilizing agent having a threadlike structure, made by a process whereby the threadlike structure is formed by emulsifying melted hydroxyl-containing stabilizing agent using an aqueous solution of an anionic surfactant. In order to provide an effecting structuring network, the threads are formed from the emulsified crystalline, hydroxyl-containing stabilizing agent under slow cooling. For instance, in the process of WO 2014/052304, molten glyceride, emulsified in a solution of anionic surfactant is slowly cooled at a cooling rate of 1-2° C./min. Since slow cooling rates are needed to form such threadlike networks, they are unsuitable for forming by continuous processes, especially “on-demand” processes whereby the structuring network is formed and immediately added to the liquid to be structured without any intermediate storage of the premix.

Since such structuring premixes comprise high amounts of water, and low levels of the lamellar structurant, they are less suited for structuring low water liquid compositions, such as those that are enclosed in a water-soluble film to form a water-soluble unit dose article. In addition, since such structuring premixes entrain water into the formulation, they limit the amount of other ingredients which can be added as part of aqueous premixes. Furthermore, higher levels of water lead to more migration of ingredients between different compartments of multi-compartment unit-dose articles. Moreover, processes which first require the formation of a structuring premix are more complex, requiring a separate processing system and a storage tank for the structuring premix.

As mentioned earlier, such premixes typically require an emulsification step involving the addition of high levels of an emulsifying agent. While the addition of these emulsification agents adds to the overall cost of the formulation, they can also affect the performance of other ingredients present in the formulation.

As such, a need remains for a process for structuring compositions, without the need for forming a separate structuring premix, or requiring high levels of water and emulsifying agents.

WO 2010/034736 describes a method of producing phosphate free liquid detergent compositions, whereby a non-aqueous premix of hydrogenated castor oil at an elevated temperature, is added to an aqueous surfactant premix, also at an elevated temperature, before cooling such that the hydrogenated castor oil crystallizes.

### SUMMARY OF THE INVENTION

The present disclosure relates to a process for making a structured liquid composition, comprising the steps of: providing a first premix comprising surfactant and non-aqueous organic solvent, and less than 30 wt % of water, wherein the first premix is at a temperature of greater than 40° C.; providing a crystalline structurant selected from the group consisting of: fatty acids, fatty esters, glycerides, fatty alcohols, or mixtures thereof; combining the crystalline structurant with a first premix to form a second premix; combining the second premix with a liquid composition at a temperature of less than 40° C., to form the structured liquid composition.

### DETAILED DESCRIPTION OF THE INVENTION

The present disclosure provides for a process for making a structured liquid detergent composition which comprises a structurant without introducing high levels of water or emulsifying agents, or requiring a separate structuring premix to be formed.

As defined herein, “essentially free of” a component means that the component is present at a level of less than 15%, preferably less 10%, more preferably less than 5%, even more preferably less than 2% by weight of the respective premix or composition. Most preferably, “essentially free of” a component means that no amount of that component is present in the respective premix, or composition.

As defined herein, “stable” means that no visible phase separation is observed for a premix kept at 25° C. for a period of at least two weeks, preferably at least four weeks, more preferably at least a month or even more preferably at least four months, as measured using the Floc Formation Test, described in USPA 2008/0263780 A1.

All percentages, ratios and proportions used herein are by weight percent of the respective premix or composition, unless otherwise specified. All average values are calculated “by weight” of the respective premix, composition, or components thereof, unless otherwise expressly indicated.

Unless otherwise noted, all component, premix, or composition levels are in reference to the active portion of that component, premix, or composition, and are exclusive of impurities, for example, residual solvents or by-products, which may be present in commercially available sources of such components or compositions.

All measurements are performed at 25° C. unless otherwise specified.

By fabric we preferably mean a textile or cloth comprising a network of natural or artificial fibers. Those skilled in the art will be aware of suitable fabrics. The fabric may be selected from cotton, polyester, cotton/polyester blends or a mixture thereof, preferably cotton. The fabric may comprise a stain, soil or mixture thereof to be removed. Those skilled in the art will be aware of suitable stains or soils to be removed.

The process of the present disclosure comprises the following steps: providing a first premix comprising surfactant and non-aqueous organic solvent, wherein the first premix is at a temperature of greater than 40° C.; providing a crystalline structurant selected from the group consisting of: fatty acids, fatty esters, glycerides, fatty alcohols, or mixtures thereof; combining the crystalline structurant with a first premix to form a second premix; combining the second premix with a liquid composition at a temperature of less than 40° C., to form the structured liquid composition.

The process steps for making the first premix and the second premix can be continuous. The process step of combining the second premix with the liquid composition to form the structured liquid composition can be continuous.

The First Premix:

The first premix comprises surfactant and non-aqueous organic solvent.

In the first premix composition, the surfactant can be present at a level of greater than 15 wt %, preferably from 20 to 95 wt %, more preferably from 25 to 50 wt %, based on total first liquid composition weight.

Suitable surfactants can be selected from the group consisting of: nonionic surfactant, anionic surfactant, and mixtures thereof. Nonionic surfactants are preferred.

Suitable nonionic surfactants may be selected from: fatty alcohol alkoxylates, oxo-synthesized fatty alcohol alkoxylates, Guerbet alcohol alkoxylates, alkyl phenol alcohol alkoxylates, alkyl polyglucoside, and mixtures thereof. Preferably, the nonionic surfactant comprises fatty alcohol ethoxylate nonionic surfactant. Even more preferably the nonionic surfactant consists of fatty alcohol ethoxylate surfactant.

Suitable fatty alcohol ethoxylate nonionic surfactants include the condensation products of aliphatic alcohols with from 1 to 25 moles of ethylene oxide. The alkyl chain of the aliphatic alcohol can either be straight or branched, guerbet, primary or secondary, and generally contains from 8 to 22 carbon atoms. The starting alcohol can be naturally derived, e.g. starting from natural oils, or synthetically derived, e.g. alcohols obtained from for example oxo-, modified oxo- or Fischer-Tropsch processes. Examples of oxo-process derived fatty alcohols include the Lial and Isalchem fatty alcohols ex Sasol company and Lutensol fatty alcohols ex BASF company. Examples of modified-oxo process derived fatty alcohols include the Neodol fatty alcohols ex

Shell company. Fischer-Tropsch derived fatty alcohols include Safol fatty alcohols ex Sasol company. The alkoxylate chain of fatty alcohol ethoxylates is made up solely of ethoxylate groups. Preferably, the fatty alcohol ethoxylate nonionic surfactant comprises on average between 8 and 18, more preferably between 10 and 16 even more preferably between 12 and 15 carbon atoms in the alcohol carbon chain, and on average between 5 and 12, preferably between 6 and 10, more preferably between 7 and 8 ethoxy units in the ethoxylation chain.

Suitable anionic surfactants include non-soap surfactants, such as those selected from the group consisting of: linear alkylbenzene sulphonates, alkyl sulphates, alkoxylated alkyl sulphates, and mixtures thereof. Preferably, the alkoxylated alkyl sulphate is an ethoxylated alkyl sulphate preferably with an average degree of ethoxylation of between 0.5 and 4, preferably between 1 and 4, more preferably between 2 and 4, most preferably about 3.

The first premix comprises a non-aqueous organic solvent. Suitable non-aqueous organic solvents can be selected from the group consisting of: ethanol, propanediol, glycerin, dipropylene glycol, propylene glycol, and mixtures thereof.

The first premix comprises less than 30 wt %, preferably less than 15 wt %, more preferably less than 10 wt %, even more preferably less than 5 wt % of water. It has been surprisingly found that when using the aforementioned first premix, dendrites of the crystalline structurant are formed, even though little water is present. It is believed that dendrites crystalline structures are able to provide improved structuring. Moreover, it has been found that the resultant structured liquid composition is less shear sensitive. As such, the second premix can be added to the liquid composition at a higher shear. Moreover, the resultant structured liquid composition is less shear-sensitive. Therefore, additional ingredients can be blended into the structured liquid composition without affecting the viscosity and structuring efficacy of the composition.

The Second Premix:

The first premix is heated to a temperature of greater than 40° C., preferably from 60° C. to 95° C., more preferably from 75° C. to 85° C., before the crystalline structurant is combined with the first premix to form a second premix.

Suitable crystalline structurants include non-polymeric, crystalline, hydroxyl-containing structuring agents. The non-polymeric, crystalline, hydroxyl-containing structuring agent can be hydrogenated castor oil. Castor oil is a triglyceride vegetable oil, comprising predominately ricinoleic acid, but also oleic acid and linoleic acids. When hydrogenated, it becomes castor wax, otherwise known as hydrogenated castor oil. The hydrogenated castor oil may comprise at least 85% by weight of the castor oil of ricinoleic acid. Preferably, the hydrogenated castor oil comprises glyceryl tris-12-hydroxystearate (CAS 139-44-6). In a preferred embodiment, the hydrogenated castor oil comprises at least 85%, more preferably at least 95% by weight of the hydrogenated castor oil of glyceryl tris-12-hydroxystearate. However, the hydrogenated castor oil composition can also comprise other saturated, or unsaturated linear or branched esters. In a preferred embodiment, the hydrogenated castor oil has a melting point in the range of from 45° C. to 95° C., as measured using ASTM D3418 or ISO 11357. The hydrogenated castor oil may have a low residual unsaturation and will generally not be ethoxylated, as ethoxylation tends to reduce the melting point temperature to an undesirable extent. By low residual unsaturation, we herein mean an iodine value of 20 of less, preferably 10 or less, more preferably 3 or less. Those skilled in the art would know how to measure the iodine value using commonly known techniques.

The crystalline structurant is preferably combined with the first premix after it has been melted. That is, after it has been heated to a temperature above its melt point. As such, the crystalline structurant is preferably heated to above 90° C. Alternatively, the crystalline structurant can be added in solid form, such as flakes or in granule form.

The crystalline structurant can be combined with the first premix using an energy dissipation rate of less than 100 W/Kg, preferably from 0.1 to 50 W/Kg, more preferably from 0.5 to 10 W/Kg. Without being bound by theory, it is believed that high energy dispersion reduces the emulsion size and increases the efficiency of the crystal growth in later steps. As a result, the crystalline structurant can be present as an emulsion or be fully dispersed in the second premix. Any suitable mixing device can be used. The mixing device typically uses mechanical energy to mix the liquids. Suitable mixing devices can include static and dynamic mixer devices. Examples of dynamic mixer devices are homogenizers, rotor-stators, and high shear mixers. The mixing device could be a plurality of mixing devices arranged in series or parallel in order to provide the necessary energy dissipation rate.

Alternatively, or in addition, the crystalline structurant and first premix can be passed through a microchannel mixing device. Microchannel mixing devices are a class of static mixers. Suitable microchannel mixing devices can be selected from the group consisting of: split and recombine mixing devices, staggered herringbone mixers, and mixtures thereof. In a preferred embodiment, the micro-channel mixing device is a split and recombine mixing device.

The Liquid Composition:

The liquid composition is combined with the second premix in order to provide the structured liquid composition. The liquid composition and second premix are combined at a temperature of less than 40° C. As such, the second premix may be cooled to a temperature of below 60° C., or from 25° C. to 60° C., preferably from 30° C. to 52° C., more preferably from 35° C. to 47° C. Without wishing to be bound by theory, it is believed that this cooling step increases the crystallinity of the crystalline structurant. The second premix is preferably cooled as quickly as possible. For instance, the second premix can be cooled in a period of from 10 s to 15 minutes, preferably in a period of less than 5 minutes, more preferably less than 2 minutes.

The second premix can be cooled to the second temperature by any suitable means, such as by passing it through a heat exchanger device. Suitable heat exchanger devices can be selected from the group consisting of: plate and frame heat exchanger, shell and tube heat exchangers, and combinations thereof.

The second premix can be passed through more than one heat exchanger device. In this case the second and subsequent heat exchanger devices are typically arranged in series with respect to the first heat exchanger. Such an arrangement of heat exchanger devices can be used to control the cooling profile of the second premix.

The second premix can be maintained at the desired temperature for at least 2 minutes. Preferably, the second premix is maintained at the second temperature for a period of from 2 to 30 minutes, preferably from 5 to 20 minutes, more preferably from 10 to 15 minutes.

Suitable liquid compositions include: products for treating fabrics, including laundry detergent compositions and rinse additives; hard surface cleaners including dishwashing compositions, floor cleaners, and toilet bowl cleaners. The process of the present invention is particularly suited for structuring liquid detergent compositions. Such liquid detergent compositions comprise sufficient detersive surfactant, so as to provide a noticeable cleaning benefit. Most preferred are liquid laundry detergent compositions, which are capable of cleaning a fabric, such as in a domestic washing machine.

As used herein, “liquid composition” refers to any composition comprising a liquid capable of wetting and treating a substrate, such as fabric or hard surface. Liquid compositions are more readily dispersible, and can more uniformly coat the surface to be treated, without the need to first dissolve the composition, as is the case with solid compositions. Liquid compositions can flow at 25° C., and include compositions that have an almost water like viscosity, but also include “gel” compositions that flow slowly and hold their shape for several seconds or even minutes.

A suitable liquid composition can include solids or gases in suitably subdivided form, but the overall composition excludes product forms which are non-liquid overall, such as tablets or granules. The liquid compositions preferably have densities in the range from of 0.9 to 1.3 grams per cubic centimetre, more preferably from 1.00 to 1.10 grams per cubic centimetre, excluding any solid additives but including any bubbles, if present.

Preferably, the liquid composition comprises from 1% to 95% by weight of water, non-aminofunctional organic solvent, and mixtures thereof. For concentrated liquid compositions, the composition preferably comprises from 15% to 70%, more preferably from 20% to 50%, most preferably from 25% to 45% by weight of water, non-aminofunctional organic solvent, and mixtures thereof.

The process of the present invention is particularly suited for structuring liquid compositions which are low in water. Such low water liquid compositions can comprise less than 15%, preferably less than 10% by weight of water.

The liquid composition of the present invention may comprise from 5.0% to 50%, more preferably from 15% to 25% by weight of a non-aminofunctional organic solvent.

When the liquid composition is a low water liquid composition, the liquid composition can also be encapsulated in a water soluble film, to form a unit dose article. Such unit dose articles comprise the structured liquid composition formed by the process of the present invention, wherein the liquid composition is a low water liquid composition, and the liquid composition is enclosed in a water-soluble or dispersible film.

The unit dose article may comprise one compartment, formed by the water-soluble film which fully encloses at least one inner volume, the inner volume comprising the low water liquid composition. The unit dose article may optionally comprise additional compartments comprising further low water liquid compositions, or solid compositions. A multi-compartment unit dose form may be desirable for such reasons as: separating chemically incompatible ingredients; or where it is desirable for a portion of the ingredients to be released into the wash earlier or later. The unit-dose articles can be formed using any means known in the art.

Suitable water soluble pouch materials include polymers, copolymers or derivatives thereof. Preferred polymers, copolymers or derivatives thereof are selected from the group consisting of: polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthan and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof.

As mentioned earlier, the liquid composition of use in the present invention can be a liquid detergent composition, preferably a liquid laundry detergent composition. Liquid detergent compositions comprise a surfactant, to provide a detergency benefit. The liquid detergent compositions of the present invention may comprise from 1% to 70%, preferably from 5% to 60%, more preferably from 10% to 50%, most preferably from 15% to 45% by weight of a detersive surfactant. Suitable detersive surfactants can be selected from the group consisting of: anionic, nonionic surfactants and mixtures thereof. More preferably, the weight ratio of anionic surfactant to nonionic surfactant is from 1:2 to 20:1, preferably from 1:1 to 15:1, more preferably from 1.5:1 to 10:1, most preferably from 5:1 to 10:1.

The liquid detergent compositions of use in the present invention preferably comprise from 1 to 50%, more preferably from 5 to 40%, most preferably from 10 to 30% by weight of one or more anionic surfactants. Preferred anionic surfactant are selected from the group consisting of: C11-C18 alkyl benzene sulphonates, C10-C20 branched-chain and random alkyl sulphates, C10-C18 alkyl ethoxy sulphates, mid-chain branched alkyl sulphates, mid-chain branched alkyl alkoxy sulphates, C10-C18 alkyl alkoxy carboxylates comprising 1-5 ethoxy units, modified alkylbenzene sulphonate, C12-C20 methyl ester sulphonate, C10-C18 alpha-olefin sulphonate, C6-C20 sulphosuccinates, and mixtures thereof. However, by nature, every anionic surfactant known in the art of detergent compositions may be used, such as those disclosed in “Surfactant Science Series”, Vol. 7, edited by W. M. Linfield, Marcel Dekker. The detergent compositions preferably comprise at least one sulphonic acid surfactant, such as a linear alkyl benzene sulphonic acid, or the water-soluble salt form of the acid. Preferably, the liquid composition comprises linear alkylbenzene sulphonate and alkoxylated alkyl sulphate, wherein the weight ratio of linear alkylbenzene sulphonate to alkoxylated alkyl sulphate is between 15:1 and 1:3, preferably 10:1 and 1:2, more preferably 5:1 and 1:1, even more preferably 3:1 and 1:1, most preferably 2:1 and 1:1.

Preferably, the weight ratio of linear alkylbenzene sulphonate to nonionic surfactant is between 2:1 to 20:1 preferably 2:1 and 10:1; more preferably 5:1 and 10:1.

Preferably, the weight ratio of alkoxylated alkyl sulphate to nonionic surfactant is between 2:1 and 20:1 preferably between 2:1 and 10:1 more preferably between 2:1 and 5:1.

Preferably, the weight ratio of linear alkylbenzene sulphonate to fatty alcohol ethoxylate nonionic surfactant is between 2:1 to 20:1 preferably 2:1 and 10:1; more preferably 5:1 and 10:1.

Preferably, the weight ratio of alkoxylated alkyl sulphate to fatty alcohol ethoxylate nonionic surfactant is between 2:1 and 20:1 preferably between 2:1 and 10:1 more preferably between 2:1 and 5:1.

The detergent compositions of use in the present invention preferably comprise up to 30%, more preferably from 1 to 15%, most preferably from 2 to 10% by weight of one or more nonionic surfactants. Suitable nonionic surfactants include, but are not limited to C12-C18 alkyl ethoxylates (“AE”) including the so-called narrow peaked alkyl ethoxylates, C6-C12 alkyl phenol alkoxylates (especially ethoxylates and mixed ethoxy/propoxy), block alkylene oxide condensate of C6-C12 alkyl phenols, alkylene oxide condensates of C8-C22 alkanols and ethylene oxide/propylene oxide block polymers (Pluronic®-BASF Corp.), as well as semi polar nonionics (e.g., amine oxides and phosphine oxides). An extensive disclosure of suitable nonionic surfactants can be found in U.S. Pat. No. 3,929,678.

The liquid detergent composition may also include conventional detergent ingredients selected from the group consisting of: additional surfactants selected from amphoteric, zwitterionic, cationic surfactant, and mixtures thereof; enzymes; enzyme stabilizers; amphiphilic alkoxylated grease cleaning polymers; clay soil cleaning polymers; soil release polymers; soil suspending polymers; bleaching systems; optical brighteners; hueing dyes; particulates; perfume and other odour control agents, including perfume delivery systems; hydrotropes; suds suppressors; fabric care perfumes; pH adjusting agents; dye transfer inhibiting agents; preservatives; non-fabric substantive dyes; and mixtures thereof.

The aqueous structuring premixes of the present invention are particularly effective at stabilizing particulates since the crystalline structurant is predominately present as dendrites, even when the liquid composition is low in water. As such, the structured liquid compositions formed by the process of the present invention provide improved low shear viscosity. Therefore, the process of the present invention is particularly suited for structuring liquid compositions which further comprise particulates. Suitable particulates can be selected from the group consisting of microcapsules, oils, and mixtures thereof. Particularly preferred oils are perfumes, which provide an odour benefit to the liquid composition, or to substrates treated with the liquid composition.

When added, such perfumes are added at a level of from 0.1% to 5%, more preferably from 0.3% to 3%, even more preferably from 0.6% to 2% by weight of the liquid composition.

Microcapsules are typically added to liquid compositions, in order to provide a long lasting in-use benefit to the treated substrate. Microcapsules can be added at a level of from 0.01% to 10%, more preferably from 0.1% to 2%, even more preferably from 0.15% to 0.75% of the encapsulated active, by weight of the liquid composition. In a preferred embodiment, the microcapsules are perfume microcapsules, in which the encapsulated active is a perfume. Such perfume microcapsules release the encapsulated perfume upon breakage, for instance, when the treated substrate is rubbed.

The microcapsules typically comprise a microcapsule core and a microcapsule wall that surrounds the microcapsule core. The microcapsule wall is typically formed by cross-linking formaldehyde with at least one other monomer. The term “microcapsule” is used herein in the broadest sense to include a core that is encapsulated by the microcapsule wall. In turn, the core comprises a benefit agent, such as a perfume.

The microcapsule core may optionally comprise a diluent. Diluents are material used to dilute the benefit agent that is to be encapsulated, and are hence preferably inert. That is, the diluent does not react with the benefit agent during making or use. Preferred diluents may be selected from the group consisting of: isopropylmyristate, propylene glycol, poly(ethylene glycol), or mixtures thereof.

Microcapsules, and methods of making them are disclosed in the following references: US 2003-215417 A1; US 2003-216488 A1; US 2003-158344 A1; US 2003-165692 A1; US 2004-071742 A1; US 2004-071746 A1; US 2004-072719 A1; US 2004-072720 A1; EP 1393706 A1; US 2003-203829 A1; US 2003-195133 A1; US 2004-087477 A1; US 2004-0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; US RE 32713; U.S. Pat. No. 4,234,627.

Encapsulation techniques are disclosed in MICROENCAPSULATION: Methods and Industrial Applications, Edited by Benita and Simon (Marcel Dekker, Inc., 1996). Formaldehyde based resins such as melamine-formaldehyde or urea-formaldehyde resins are especially attractive for perfume encapsulation due to their wide availability and reasonable cost.

The microcapsules preferably have a size of from 1 micron to 75 microns, more preferably from 5 microns to 30 microns. The microcapsule walls preferably have a thickness of from 0.05 microns to 10 microns, more preferably from 0.05 microns to 1 micron. Typically, the microcapsule core comprises from 50% to 95% by weight of the benefit agent.

The second premix can be combined with the liquid composition using an energy dissipation rate of greater than 0.1 W/Kg, preferably from 1 to 200 W/Kg, more preferably from 5 to 100 W/Kg, for instance, using means as described earlier.

Methods:

A) pH Measurement:

The pH is measured on the neat composition, at 21° C., using a pH meter with compatible gel-filled pH probe (such as Sartarius PT-10P meter with Toledo probe part number 52 000 100), calibrated according to the instructions manual.

B) Method for Determining Dynamic Yield Stress and Viscosity:

Dynamic yield stress and viscosity are measured using a controlled stress rheometer (such as an HAAKE MARS from Thermo Scientific, or equivalent), using a 60 mm 1° Cone and a gap size of 52 microns at 20° C. The Dynamic yield stress is preferably measured on the composition before the addition of any particles, such as perfume microcapsules and the like. Where particles are present, a 60 mm plate-plate geometry should be used, with a gap size of 1000 microns.

The dynamic yield stress is obtained by measuring quasi steady state shear stress as a function of shear rate starting from 10 s⁻¹ to 10's⁻¹, taking 25 points logarithmically distributed over the shear rate range. Quasi-steady state is defined as the shear stress value once variation of shear stress over time is less than 3%, after at least 30 seconds and a maximum of 60 seconds at a given shear rate. Variation of shear stress over time is continuously evaluated by comparison of the average shear stress measured over periods of 3 seconds. If after 60 seconds measurement at a certain shear rate, the shear stress value varies more than 3%, the final shear stress measurement is defined as the quasi state value for calculation purposes. Shear stress data is then fitted using least squares method in logarithmic space as a function of shear rate following a Herschel-Bulkley model:

τ=τ₀+kγ′ⁿ

wherein τ is the measured equilibrium quasi steady state shear stress at each applied shear rate τ₀ is the fitted dynamic yield stress. k and n are fitting parameters.

C) Energy Dissipation rate:

In a continuous process comprising a static emulsification device, the energy dissipation rate is calculated by measuring the pressure drop over the emulsification device, and multiplying this value by the flow rate, and then dividing by the active volume of the device. In the case where an emulsification is conducted via an external power source, such as a batch tank or high shear mixer, the energy dissipation is calculated via the following Formula 1 (Kowalski, A. J., 2009, Power consumption of in-line rotor-stator devices. Chem. Eng. Proc. 48, 581.);

P_{f}=P_{T}+P_{F}+P_{L}

Wherein P_{T} is the power required to rotate the rotor against the liquid, P_{F} is the additional power requirements from the flow of liquid and P_{L} is the power lost, for example from bearings, vibration, noise etc.

D) Crystal Size:

The crystal size is measured as the D[4,3] size using laser scattering (such as Malvern Mastersizer 2000 with Hydro MU dispersing unit). Crystallized hydrogenated castor oil is directly measured without any further treatment. The instrument cell is cleaned and then filled with demineralised water. If the background has a laser intensity above 79%, the system is considered clean and the sample can be added to the vessel until the desired obscuration is achieved. Then ultrasounds are switched on for 30 seconds and once the sample is well dispersed, the measurement can start.

Then, the crystal size (volume weight mean D[4,3]) is measured. The crystal size measured is the diameter of the equivalent sphere that has the same translational diffusion coefficient as the crystalline structure being measured assuming a hydration layer surrounding the crystalline structure.
Sampler selection: Hydro 2000MU
Sampler settings:
   Pump/stir speed: 2500 rpm
   Ultrasonics: 30 seconds
Material:
   Refractive Index of the material: 1.53
   Dispersant used: demineralised water in an amount as needed
   Particle shape: Irregular
Measurement:
   Measurement cycles: 3 measurements per aliquot with a delay of 10 seconds
   Measurement time: 10 seconds
   Measurement snaps: 10,000
   Background time: 10 seconds
   Background snaps: 10,000
   Lower obscuration limit: 5
   Upper obscuration limit: 15

### EXAMPLES

### Example 1 (Comparative): Preparation of the Hydrogenated Castor Oil Premix

96.21 grams 1,2-Propanediol (Sigma-Aldrich) are heated up to 80° C. in a 250 mL beaker with a hot plate stirrer, then 1 gram of hydrogenated castor oil (Thixcin® supplied by Elementis) is added. The premix is mixed at 80° C. for 30 minutes at 400 rpm, heating is stopped and premix is allowed to cool down to 25° C. under agitation. Mean crystal particle size D[4,3] is 80 microns and dynamic yield stress 0.007 Pa.

### Example 2: Preparation of Hydrogenated Castor Oil for Use in the Process of the Present Invention

Composition A (described below), an unstructured liquid laundry detergent composition, was prepared by simple mixing. 99.5 grams Composition A are heated up to 80° C. in a 250 mL beaker with a hot plate stirrer, then 1 gram of hydrogenated castor oil (Thixcin® supplied by Elementis) is added. The premix is mixed at 80° C. for 30 minutes at 400 rpm, heating is stopped and premix is allowed to cool down (at an average rate of 2° C./min) to 25° C. under agitation. Mean crystal particle size D[4,3] is 35 microns and dynamic yield stress 0.35 Pa.

| Composition A | % wt |
|---|---|
| C12-14 EO9 ethoxylated alcohol | 18.5 |
| C12-15 EO2.5 alkyl ethoxylated sulfate | 11 |
| Linear Alkylbenzene Sulfonic Acid | 22.3 |
| Citric Acid | 1.1 |
| C₁₂₋₁₈ Fatty Acid | 7.6 |
| Ethoxylated Polyethylenimine¹ | 7.4 |
| Diethylenetriaminepentaacetic acid (DTPA) | 1 |
| 1,2 propanediol | 11 |
| Glycerol | 6.2 |
| Monoethanolamine | 6.3 |
| Minors: stabilizers and aesthetics | Up to 2% |
| Water | Up to 100% |

¹Polyethyleneimine (MW = 600) with 20 ethoxylate groups per —NH, supplied by BASF

### Example 3: Preparation of Hydrogenated Castor Oil for Use in the Process of the Present Invention

192 grams Composition A (described below) are heated up to 80° C. in a 250 mL beaker with a hot plate, then 8 grams of Thixcin (Elementis) are added. The premix is mixed at 80° C. for 30 minutes at 600 rpm with a 4 blade impeller, heating is stopped and premix is allowed to cool down (at an average rate of 2° C./min) to 25° C. at 300 rpm.

### Composition Examples: Compositions Comprising Premixes of Examples 1 and 2

| | EXAMPLE 4 | |
|---|---|---|
| Ingredients (wt %) | (comparative) | EXAMPLE 5 |
| C12-14 EO9 ethoxylated alcohol | 13.9 | 9.3 |
| C12-15 EO2.5 alkyl ethoxylated sulfate | 8.3 | 5.5 |
| Linear Alkylbenzene Sulfonic Acid | 16.7 | 11.2 |
| Citric Acid | 0.8 | 0.6 |
| C₁₂₋₁₈ Fatty Acid | 5.7 | 3.8 |
| Ethoxylated Polyethylenimine¹ | 5.6 | 3.7 |
| DTPA | 0.8 | 0.5 |
| 1,2 propanediol | 2.0 | 22.3 |
| Glycerol | 4.7 | 3.1 |
| Mono Ethanol Amine | 4.7 | 3.2 |
| Hydrogenated castor oil of Example 1 | 25 | — |
| Hydrogenated castor oil of Example 2 | — | 25 |
| Enzymes | 1.5 | 1.5 |
| Perfume | 0.8 | 0.8 |
| Encapsulated perfume | 0.4 | 0.4 |
| Minors: stabilizers and aesthetics | Up to 1% | Up to 1% |
| Water | Up to 100% | Up to 100% |
| Dynamic Yield Stress (Pa) | <0.00001 | 0.003 |

Example 4 (comparative) with a hydrogenated castor oil premix made as in example 1 by using a solvent. When using a solvent for the crystallization, it is possible to obtain hydrogenated castor oil crystals, however the size of this crystals as measured by laser scattering is bigger than crystals formed in a surfactant environment.

The size of the crystals is important when it comes to rheology properties. Example 1 and 2 show 1% hydrogenated castor oil premixes in solvent and surfactant based composition respectively. Dynamic yield stress of the premix in the surfactant based composition is higher than in the solvent. Therefore, when adding these premixes to the final product (examples 4 and 5) suspension power of the crystallized hydrogenated castor oil in the surfactant based composition is high enough to suspend particles, while the dynamic yield stress of comparative example 3 could not be determined observing creaming of the perfume encapsulates added to the formulation.

### Example 6: Hydrogenated Castor Oil of Use in Processes of the Present Invention

Composition B (described below), an unstructured liquid laundry detergent composition, was prepared by simple mixing. 194.2 grams Composition B (described below) are heated up to 51° C. in a 500 mL beaker with a hot plate stirrer, then 1 gram of molten Thixcin (Elementis) is added. The premix is mixed at 51° C. for 30 minutes at 400 rpm, heating is stopped and premix is allowed to cool down (at an average rate of 2° C./min) to 25° C. under agitation. Dynamic yield stress is 0.16 Pa.

| Composition B | % wt |
|---|---|
| Plurafac LF223 (BASF) | 28.7 |
| Lutensol XP40 | 42 |
| Violet V200 (Milliken) | 10.5 |
| Organic solvent (propanediol, | 13.25 |
| glycerol, dipropyleneglycol, | |
| ethanol) | |
| Water | up to 100% |

### Example 7: Multi-Compartment Composition

The following are examples of unit dose executions wherein the liquid composition is enclosed within a PVA film. In one aspect, the film used in the present examples is Monosol M8630 76 μm thickness.

| | 7A | | | 7B | | |
|---|---|---|---|---|---|---|
| | 3 Compartments | | | 3 Compartments | | |
| | 1 | 2 | 3 | 1 | 2 | 3 |
| | (34 mL) | (3.5 mL) | (3.5 mL) | (25 mL) | (1.5 mL) | (4 mL) |
| Ingredient (wt %) | (bottom) | (top) | (top) | (bottom) | (top) | (top) |
| C12-14 EO9 ethoxylated alcohol | 5 | — | 6 | 15 | — | — |
| Alkyl ethoxy sulfate | 15 | — | 16 | 10 | — | — |
| Linear Alkylbenzene sulfonic acid | 20 | — | 18 | 15 | — | — |
| Citric Acid | 1 | — | 2 | 0.5 | — | — |
| Fatty Acid | 5 | — | 13 | 10 | — | — |
| Enzymes | 1 | — | — | 1.5 | — | — |
| Chelant | 2 | — | 2.2 | 2 | — | — |
| Fluorescent brightener | 0.5 | — | 0.2 | 0.3 | — | — |
| Composition Example 2 | 15 | — | — | 25 | — | — |
| Organic solvent (propanediol, glycerol, | 15 | — | 25 | 15 | — | 8 |
| dipropyleneglycol, ethanol) | | | | | | |
| Mono Ethanol Amine | 10 | — | 10 | 6 | — | — |
| Composition Example 6 | | 100 | — | — | 100 | 80 |
| Perfume | 1.7 | — | — | — | — | 5 |
| Perfume microcapsules | 0.4 | — | — | 0.4 | — | — |

| | | |
|---|---|---|
| Water and minors (perfume, dye, | Up to 100% | Up to 100% |
| preservatives,.) | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a structured liquid composition, comprising the steps of:
a) providing a first premix comprising surfactant and non-aqueous organic solvent, and less than about 30 wt % of water, wherein the first premix is at a temperature of greater than about 40° C.;
b) providing a crystalline structurant selected from the group consisting of: fatty acids, fatty esters, glycerides, fatty alcohols, or mixtures thereof;
c) combining the crystalline structurant with a first premix to form a second premix;
d) combining the second premix with a liquid composition at a temperature of less than about 40° C., to form the structured liquid composition.

2. The process according to claim 1, wherein in the first premix composition, the surfactant is present at a level of greater than about 15 wt %, based on total first liquid composition weight.

3. The process according to claim 2, wherein in the first premix composition, the surfactant is present at a level of from about 25 to about 50 wt %, based on total first liquid composition weight.

4. The process according to claim 1, wherein in the first premix composition, the surfactant is selected from: nonionic surfactant, anionic surfactant, and mixtures thereof.

5. The process according to claim 1, wherein in the first premix composition, the surfactant is nonionic surfactant.

6. The process according to claim 1, wherein in the first premix, the non-aqueous organic solvent is selected from the group consisting of: ethanol, propanediol, glycerine, dipropylene glycol, propylene glycol, and mixtures thereof.

7. The process according to claim 1, wherein the first premix comprises less than about 15 wt % of water.

8. The process according to claim 1, wherein the first premix comprises less than about 5 wt % of water.

9. The process according to claim 1, wherein the crystalline structurant is selected from glycerides.

10. The process according to claim 9, wherein the crystalline structurant is hydrogenated castor oil.

11. The process according to claim 1, wherein the crystalline structurant is combined with the first premix using an energy dissipation rate of less than about 100 W/Kg.

12. The process according to claim 11, wherein the crystalline structurant is combined with the first premix using an energy dissipation rate of from about 0.5 to about 10 W/Kg.

13. The process according to claim 1, wherein the second premix is combined with the liquid composition using an energy dissipation rate of greater than about 0.1 W/Kg.

14. The process according to claim 13, wherein the second premix is combined with the liquid composition using an energy dissipation rate of from about 5 to about 100 W/Kg.

15. The process according to claim 1, wherein the ratio of crystalline structurant to first premix is from about 2:98 to about 20:80.

16. The process according to claim 15, wherein the ratio of crystalline structurant to first premix is from about 4:96 to about 8:92.

17. The process according to claim 1, wherein the ratio of the second premix to the liquid composition is from about 1:1 to about 1:40.

18. The process according to claim 1, wherein the liquid composition comprises surfactant, at a level of greater than about 15 wt %.

19. The process according to claim 1, wherein the structured liquid composition comprises an adjunct ingredient selected from the group consisting of: enzymes, encapsulates, perfume, cleaning polymers, silicones, and mixtures thereof.

20. The process according to claim 1, wherein the process step for making the first premix and the second premix are continuous, preferably wherein the process step of combining the second premix with the liquid composition to form the structured liquid composition is also continuous.
